(19) United States
(12) Patent Application Publication
(10) Pub. No.: US 2007/0131803 A1
(43) Pub. Date: Jun. 14, 2007

(54) Fuel injector having integrated valve seat guide

(76) Inventor: Milind V. Phadke, Rochester, NY (US)

Correspondence Address: DELPHI TECHNOLOGIES, INC., M/C 480-410-202, PO BOX 5052, TROY, MI, 48007, US

(21) Appl. No.: 11/302,315

(22) Filed: Dec. 13, 2005

(51) Int. Cl. B05B 1/30

(52) U.S. Cl. 239/585.1; 239/585.4; 239/900; 239/533.11; 239/533.12

(57) ABSTRACT

A fuel injector for an internal combustion engine having an integrated seat guide cold forged of precipitation hardened stainless steel wherein the integrated seat guide having superior corrosion resistance and welding characteristics to a stainless steel injector body. The integrated seat guide includes a fuel outlet, a valve seat disposed about said fuel outlet, a guide portion adjacent to said valve seat, an end surface opposite said fuel outlet, and an annular shoulder with an annular weld affixing integrated seat guide to injector body.

### TECHNICAL FIELD OF INVENTION

The present invention relates to a fuel injector for an internal combustion engine having an integrated seat guide, and more particularly, to such fuel injector wherein the integrated seat guide is formed of cold forged, precipitation hardened stainless steel and welded to an injector body.

### BACKGROUND OF INVENTION

In a modern automobile, fuel injectors are used to deliver fuel into an air stream to form a mixture that is fed into the combustion chambers of an engine. Referring to FIGS. 5 and 6, a conventional fuel injector known in the art has a stainless steel injector body 130 that houses a valve member 120 having a valve tip 140 that reciprocates relative to a valve guide 110 and valve seat 100.

In the closed position, the valve tip 140 engages the valve seat 100 to prevent fuel flow. Periodically, the valve member 120 is retracted so that the valve tip 140 is spaced apart from the valve seat 100 to allow fuel flow into the air stream. As the valve member 120 moves reciprocally, a valve guide 110 engages the valve tip 140 in order to prevent the lateral displacement of the valve member 120 and to assure proper engagement of the valve tip 140 with the valve seat 100.

A conventional seat guide assembly 150 includes a valve seat 100 and a valve guide 110 that are manufactured independently, assembled, and diffusion bonded together as a single unit. Manufacturing difficulties can occur due to the numerous process steps in the conventional method of manufacturing a seat guide assembly from separate components.

It has been proposed to machine an integrated seat guide from a single workpiece. However, machining an integrated seat guide from a single workpiece increases the complexity of manufacturing due to the intricate design and tolerances required, thereby increasing the cost.

It also has been proposed to manufacture an integrated seat guide by forging a blank to the desired shape and size. For this purpose, a low carbon martensitic stainless steel (AISI 420, 0.2% carbon) is cold forged to the required design dimensions. However, low carbon martensitic stainless steel does not have the required durability and exhibits wear when subjected to repeated contact with the valve tip, thereby reducing the operating life of the fuel injector.

In order to improved durability, an integrated seat guide forged from low carbon martensitic stainless steel is heat treated in a nitrogen atmosphere to form a nitride case characterized by a high hardness. However, when the case-hardened integrated valve is welded to the injector body, the presence of nitrogen in the steel renders the weld susceptible to sensitization, whereby chromium around the grain boundaries is depleted because of the formation of chromium nitride precipitates. This reduces corrosion resistance and renders the weld susceptible to premature failure due to cracking.

Therefore, a need exists for a fuel injector having an integrated seat guide that is manufactured from a single workpiece by forging operations, preferably cold forging, and readily welded to a stainless steel injector body. Furthermore, it is desired that the integrated seat guide have good corrosion resistance and durability to withstand repeated engagement with the valve member and valve tip, so as to provide an extended operating life for the injector.

### SUMMARY OF THE INVENTION

This invention provides a fuel injector for an internal combustion engine that includes an injector body, a forged integrated seat guide, and a valve member having a valve tip. The injector body defines an elongated cavity having a longitudinal axis. The forged integrated seat guide is disposed within the elongated cavity and includes a fuel outlet, a valve seat disposed about the fuel outlet, and a guide portion adjacent the valve seat. The valve member is received in the cavity and axially reciprocates relative to the forged integrated seat guide between an open position wherein the valve tip is axially spaced apart from the valve seat to allow fluid flow through the fuel outlet, and a closed position wherein the valve tip engages the valve seat to prevent fluid flow. Also, the guide portion of the integrated valve seat engages the valve tip as it reciprocates to prevent lateral displacement.

In another aspect of this invention, a method is provided to manufacture a fuel injector having an injector body and a cold forged integrated seat guide received in an elongated cavity of the injector body. The method includes providing an injector body defining an elongated cavity and composed of stainless steel, forging a blank to form a workpiece having a desired size and shape of the integrated seat guide, heat treating the workpiece to form the integrated seat guide, disposing the integrated seat guide within the elongated cavity, and welding the integrated seat guide to the injector body.

In accordance with this invention, the forged integrated seat guide is formed of a precipitation-hardened stainless steel that is suited for forming by cold forging from a single blank. An integrated seat guide form of precipitation-hardened stainless steel offers superior weldability to a stainless injector body, provides good corrosion resistance, and durability for the life of the fuel injector.

### BRIEF DESCRIPTION OF DRAWINGS

The accompanying drawings illustrate a preferred embodiment of the present invention. The present invention will be further described with reference to the accompanying drawings in which:

FIG. 1 is a partial cross-sectional view of a fuel injector in accordance with the present invention along its longitudinal axis.

FIG. 2 is an enlarged cross-sectional view of a portion of the injector body shown in FIG. 1 depicting a valve tip and an integrated seat guide.

FIG. 3 is a top view of an integrated seat guide shown in FIG. 2.

FIG. 4 is a side view of an integrated seat guide shown in FIG. 2.

FIG. 5 is a partial cross-sectional view of a conventional prior art fuel injector along its longitudinal axis.

FIG. 6 is an enlarged cross-section view of a portion of the injector body shown in FIG. 5 depicting a prior art seat guide assembly.

### DESCRIPTION OF THE PREFERRED EMBODIMENT

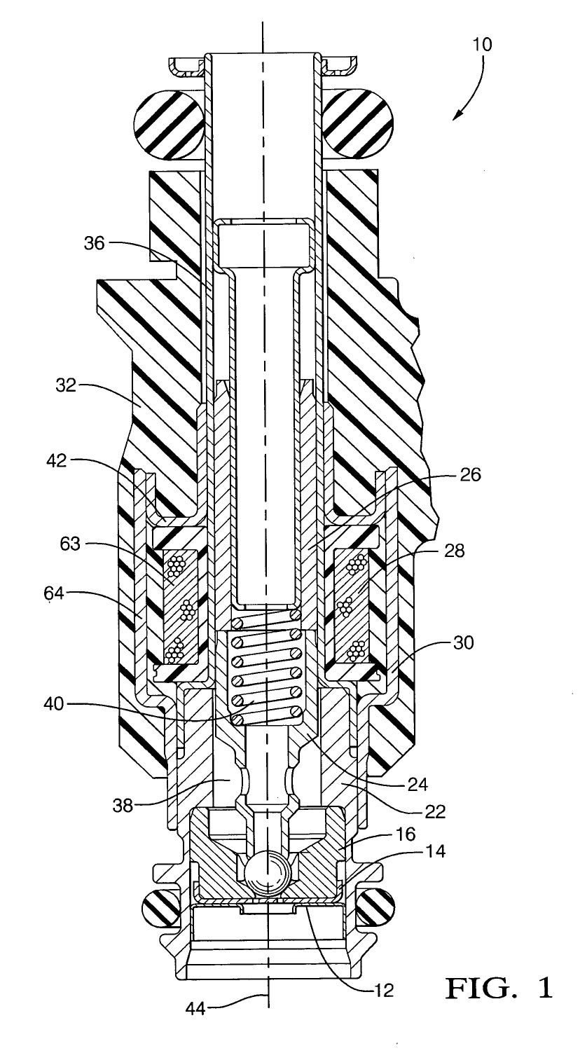

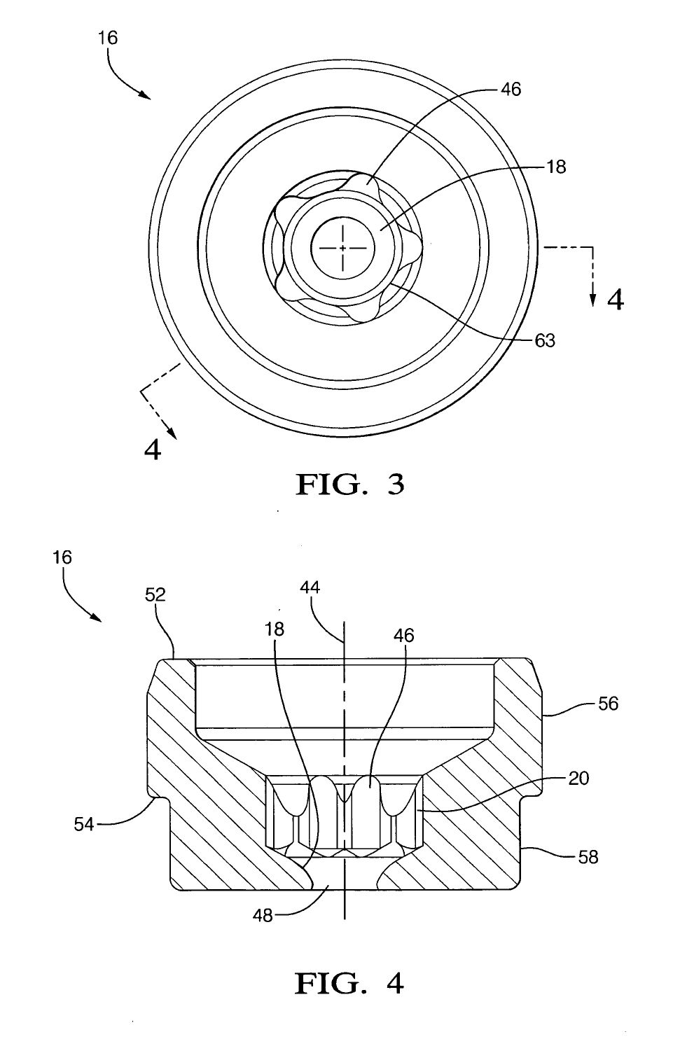

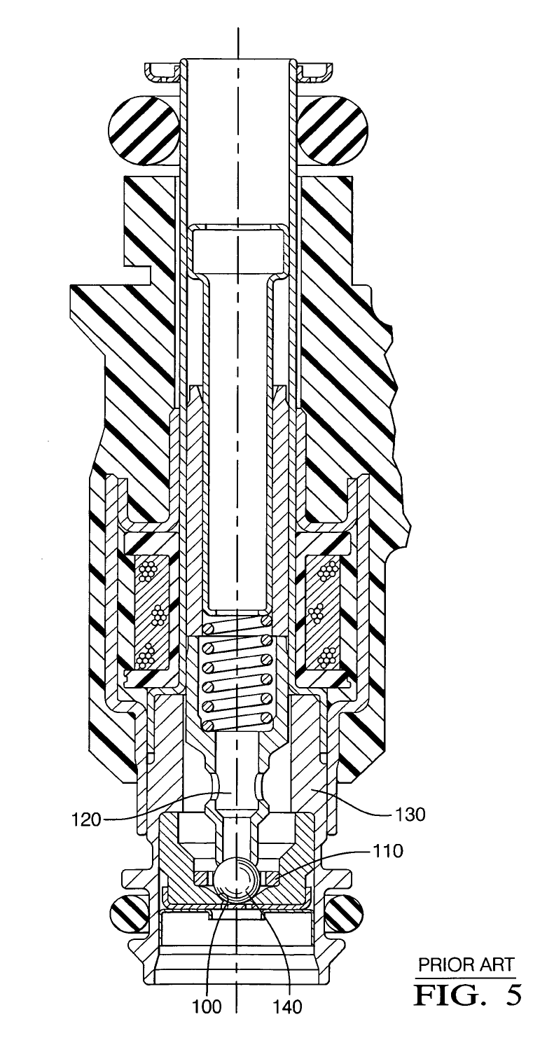

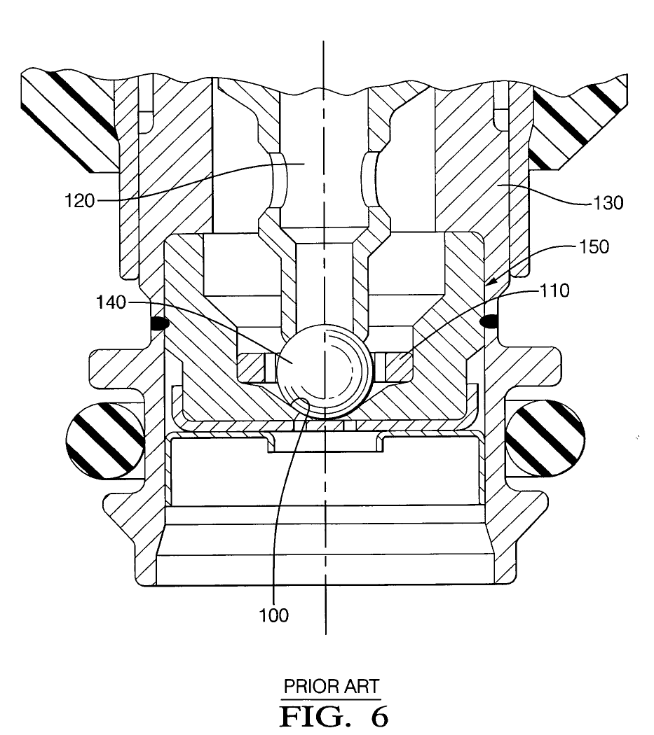

In accordance with a preferred embodiment, referring to FIGS. 1 through 4, a fuel injector 10 of this invention is adapted for use in an internal combustion engine (not shown), such as an automotive engine to inject fuel into an air stream to form a mixture that is fed into a combustion chamber. Fuel injector 10 includes a plastic solenoid housing 32 that encloses fuel tube 36 for the conveyance of fuel and electromagnetic means to cooperate with valve elements for the opening and closing of fuel outlet 48.

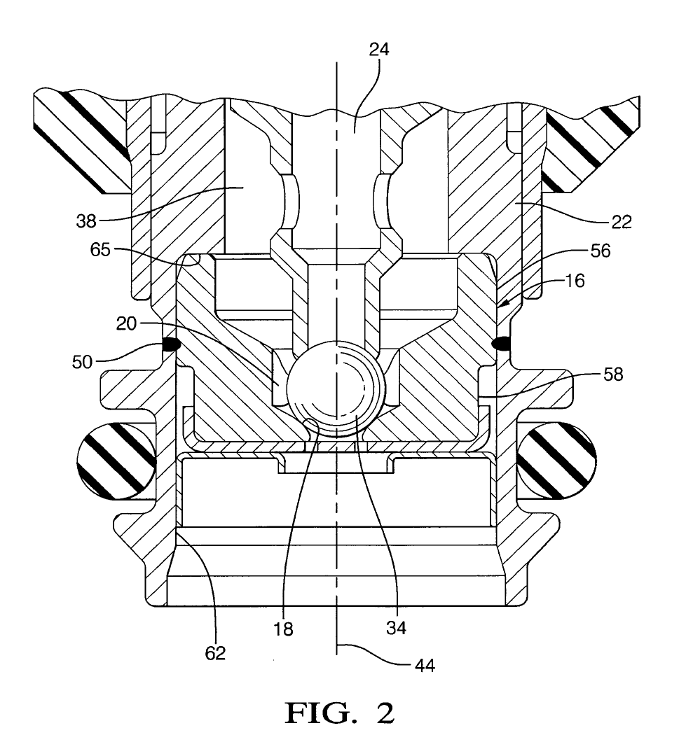

Partially enclosed in solenoid housing 32 and coaxially engaged with fuel tube 36 is an injector body 22. Referring to FIG. 2, injector body 22 is formed of a ferritic stainless steel and defines an axially elongated cavity 38. A valve member 24 is disposed within cavity 38 and moves reciprocally along the longitudinal axis 44. Member 24 includes a valve tip 34. In accordance with this invention, integrated seat guide 16 is disposed within the injector body adjacent to engage tip 34 for purposes of closing the fuel outlet 48 to prevent fuel flow.

Referring to FIGS. 1 through 4, integrated seat guide 16 includes a fuel outlet 48, valve seat 18 disposed about the fuel outlet 48 for contact with valve tip 34, and guide portion 20. Guide portion 20 includes a plurality of axial guide ribs 63 that engage valve tip 34 and are spaced apart by channels 46. During opening and closing, as valve tip 34 reciprocates axially relative to guide portion 20, guide ribs 63 guide valve tip 34 to assure axial travel and avoid lateral displacement. Channels 46 provide hydraulic communication between valve seat 18 and elongated cavity 38 to allow fuel flow through outlet 48 when valve tip 34 is spaced apart from valve seat 18.

Integrated seat guide 16 further includes an end surface 52 opposite fuel outlet 48. Integrated seat guide 16 is received within the inner circumferential wall 62 of the injector body 22 wherein the end surface 52 is in contact with an annular shoulder 65 the injector body 22.

Integrated seat guide 16 still further includes a second outer wall portion 56 that fits against the inner wall 62 of injector body 22, a first outer wall portion 58 spaced apart from inner wall 62, and an annular shoulder 54 therebetween. During assembly, integrated seat guide 16 is laser welded to the inner circumferential wall 62 of the injector body 22. The weld forms a continuous and fluid tight seam weld 50 located at the interface of the second portion outer wall 56 and the inner circumferential wall of the injector body 22.

Disposed on the end of the integrated seat guide 16 having the fuel outlet 48 is a director 14 for dispersing and directing fuel from the fuel injector into the air stream. The director is retained in position with a director retainer 12.

The electromagnetic means includes a coil subassembly 28 positioned within a coil carrier 64. The coil carrier 64 is attached to injector body 22 at one end and a coil carrier retainer 42 on the other end. The coil carrier retainer 42 is engaged with the fuel tube 36. The coil carrier 64 and coil carrier retainer 42 is used to position the coil subassembly 28 during the molding of the solenoid housing 32. The electromagnetic means further includes a pole piece 26 that is co-axially affixed to the circumferential inner wall of the fuel tube 36.

Co-axially engaged with valve member 24 is coil spring 40. In a closed position, coil spring 40 biases valve member 24 toward integrated seat guide 16 causing valve tip 34 to engage with valve seat 18 thereby obstructing fuel outlet 48.

In response to a magnetic field created by an electrical current conducted through the coil, the pole piece 26 causes the valve member 24 to moves along axis 44, axially spacing the valve tip 34 apart from the valve seat 18 to allow fuel flow through channels 46 to the combustion chamber of an engine. As the coil 28 is de-energized, coil spring 40 biases the valve member 24 toward integrated seat guide inducing valve tip 34 to engage valve seat 18; thereby obstructing the fuel outlet 48 to prevent fuel flow. As the valve member moves reciprocally from the open to close position and vice-versa, the guide portion 20 engages the valve tip 34 in order to prevent the lateral displacement of the valve member 24.

In accordance with the preferred embodiment of this invention, integrated seat guide 16 is cold forged from a blank composed of a precipitation hardenable stainless steel designated by ASTM as grade 631, UNS S17700, and commercially known as 17-7PH.

A suitable stainless steel having, by weight, up to about 0.15 percent carbon, about 16.00 to 20.00 percent chromium, about 6.00 to 8.00 percent nickel, and about 0.50 to 1.75 percent aluminum, up to about 1.00 percent manganese, up to about 0.04 percent phosphorus, up to about 0.03 percent sulfur, and up to about 1 percent silicon.

A preferred stainless steel composition having, by weight, of up to about 0.09 percent carbon, about 16.00 to 18.00 percent chromium, about 6.50 to 7.75 percent nickel, and about 0.75 to 1.50 percent aluminum.

For cold forging, the workpiece is obtained in a soft or annealed state (bar form), referred to commercially as Condition A and characterized by an austenitic microstructure. Receiving material in this condition allows for it to be easily cold forged. The blank is inserted into a die having substantially the size and shape of the desired integrated seat guide and subjected to pressure sufficient to deform the blank. Forging is preferably carried out at a temperature between about 0 and 100° C. (32 and 212° F.). As the steel is forged to the desired shape and dimensions, cold working transforms the microstructure into a predominantly martensitic microstructure, referred to commercially as Condition C. The martensitic transformation is due to a stress-induced or deformation induced transformation of the austenitic structure during cold working.

Following forging, it is believed that the martensitic steel provides a hardened, durable valve seat effective to withstand repeated closing contact with the valve tip. Alternately, the steel may be further hardened by a precipitation hardening or ageing heat treatment. A preferred hardening treatment includes heating at between about 476 and 488° C. (890 and 910° F.), for a time on the order of about 30 to 60 minutes, followed by air cooling to room temperature, and forms a state referred to commercially as CH 900. The microstructure is now martensitic with a fine dispersion of intermetallic precipitates that further harden the structure. Preferably, it is desired to avoid introduction of carbon or nitrogen into the steel surface that might interfere with the desired welding operations.

The present invention overcomes the limitations of the prior arts by allowing the valve seat and guide portion to be manufactured as an integrated unit from a single work piece, and have both superior corrosion and weldability characteristic to a stainless steel injector body. The resultant material is more corrosion resistant than low carbon martensitic stainless steel. From industry product sheets, the resultant strength appears to be close to the existing heat-treated AISI 420 grade used for seats in the existing art.

The unique feature of this invention is that the material can easily be cold forged in its as-received condition compared to conventional martensitic stainless steels, thereby reducing tool wear and improving productivity. By nature of the composition of the material, it hardens through cold working and subsequent precipitation hardening. The biggest advantage of the invention, however, lies in the ease of welding without susceptibility to inter-granular cracking, good corrosion resistance, and durability, thereby providing an extended operating life for the injector.

While this invention has been described in terms of the preferred embodiment thereof, it is not intended to limit the invention to the precise form disclosed. The scope of the invention is that described in the following claims.

We claim:

1. A fuel injector for an internal combustion engine comprising:
an injector body defining an elongated cavity having a longitudinal axis;
a forged integrated seat guide disposed within said elongated cavity, wherein said integrated seat guide comprises a fuel outlet, a valve seat disposed about said fuel outlet, and a guide portion adjacent said valve seat; and
a valve member having a valve tip received in said longitudinal axis and axially reciprocal relative to said forged integrated seat guide between an open position wherein said valve tip is axially spaced apart from the valve seat to allow fluid flow through said fuel outlet, and a closed position wherein said valve tip engages valve seat to prevent fluid flow;
wherein said guide portion engages said axially reciprocal valve tip to prevent lateral displacement of said axially reciprocal valve member between said open and closed positions;
wherein said forged integrated seat guide is formed of a precipitation hardened stainless steel; and
wherein said forged integrated seat guide is welded to said injector body.

2. A fuel injector in accordance with claim 1:
wherein said injector body comprises a first end and a second end, wherein said first end comprises an inner circumferential wall;
wherein said forged integrated seat guide comprises an outer wall and is received in said first end wherein said outer wall of said forged integrated seat guide is in contact with said inner circumferential wall of said injector body; and
wherein said fuel injector includes a weld between said outer wall of said integrated seat guide and inner circumferential wall of said injector body.

3. A fuel injector in accordance with claim 2:
wherein said inner circumferential wall of said injector body comprises an end that includes an annular shoulder;
wherein said forged integrated seat guide comprises an end surface opposite said fuel outlet; and
wherein said forged integrated seat guide is received in said first end such that said end surface of said forged integrated seat guide is in contact with said annular shoulder of said inner circumferential wall of said injector body.

4. A fuel injector in accordance with claim 2:
wherein said outer wall of said forged integrated seat guide comprises an annular shoulder defining a first portion outer wall and a second portion outer wall;
wherein said second portion outer wall is in contact with said inner circumferential wall of said injector body;
wherein said first portion outer wall is spaced apart from said inner circumferential wall of said injector body; and
wherein said weld is located at the interface where the second portion outer wall is in contact with said inner circumferential wall of said injector body.

5. A fuel injector in accordance with claim 2:
wherein said weld between said outer wall of said integrated seat guide and inner circumferential wall of said injector body is continuous and fluid tight.

6. A fuel injector in accordance with claim 1:
wherein the weld is a laser weld.

7. A fuel injector in accordance with claim 1:
wherein said precipitation hardened stainless steel comprises, by weight, up to about 0.15 percent carbon, about 16.00 to 20.00 percent chromium, about 6.00 to 8.00 percent nickel, and about 0.50 to 1.75 percent aluminum.

8. A fuel injector in accordance with claim 1:
wherein said precipitation hardened stainless steel comprises, by weight, up to about 0.09 percent carbon, about 16.00 to 18.00 percent chromium, about 6.50 to 7.75 percent nickel, and about 0.75 to 1.50 percent aluminum.

9. A fuel injector in accordance with claim 8:
wherein said precipitation hardened stainless steel further comprises, by weight, up to about 1.00 percent manganese, up to about 0.04 percent phosphorus, up to about 0.03 percent sulfur, and up to about 1 percent silicon.

10. A fuel injector in accordance with claim 1 wherein said guide portion comprises:
at least one rib guide engages with said valve tip to prevent lateral displacement of said axially reciprocal valve member; and
at least one channel spaced between said at least one rib guide.

11. A fuel injector for an internal combustion engine comprising:
a stainless steel injector body defining an elongated cavity having a longitudinal axis; wherein said injector body comprises a first end and a second end, wherein said first end comprises an inner circumferential wall including an annular shoulder therein;
a cold forged integrated seat guide disposed within said elongated cavity, wherein said integrated seat guide comprises a fuel outlet, a valve seat disposed about said fuel outlet, an end surface opposite said fuel outlet engaged with said annular shoulder of said inner circumferential wall, an annular shoulder defining a first portion outer wall and a second portion outer wall, and a guide portion adjacent said valve seat; wherein said guide portion comprise of at least one rib guide and at least one channel spaced between said rib guide; and
a valve member having a valve tip received in said longitudinal axis and axially reciprocal relative to said forged integrated seat guide between an open position wherein said valve tip is axially spaced apart from said valve seat to allow fluid flow through said fuel outlet, and a closed position wherein said valve tip engages said valve seat to prevent fluid flow;
wherein said forged integrated seat guide is affixed to said inner circumferential wall of injector body with a liquid tight continuous seam weld.

12. A cold forged integrated seat guide in accordance with claim 11 is formed of precipitation hardened stainless steel.

13. A cold forged integrated seat guide in accordance with claim 11:
comprises up to about 0.09 percent carbon, about 16.00 to 18.00 percent chromium, about 6.50 to 7.75 percent nickel, and about 0.75 to 1.50 percent aluminum.

14. A cold forged integrated seat guide in accordance with claim 13:
comprises up to about 1.00 percent manganese, up to about 0.04 percent phosphorus, up to about 0.03 percent sulfur, and up to about 1 percent silicon.

15. A method of manufacturing a fuel injector comprising an injector body and a cold forged integrated seat guide received in an elongated cavity of the injector body, said method comprising:
providing an injector body defining an elongated cavity and composed of stainless steel;
forging a blank to form a workpiece having a desired size and shape of the integrated seat guide, wherein said blank initially being in an austenitic state and transformed to martensitic state during forging process;
heat-treating said workpiece to form said integrated seat guide, wherein said heat treating being carried out to precipitation harden said seat guide;
disposing the integrated seat guide within the elongated cavity; and welding the integrated seat guide to the injector body.

16. A method of manufacturing a fuel injector in accordance with claim 15, wherein said process of cold forging is carried out at a temperature between 32° F. and 212° F.

17. A method wherein the heat treating step comprises:
raising workpiece to a temperature of about 900° F.;
holding said workpiece at about 900° F. between about 30 to 60 minutes; and
air-cooling said workpiece to ambient room temperature resulting in a precipitation hardened state referred to commercially as CH900.

18. A method of manufacturing a fuel injector in accordance with claim 15, wherein said injector body comprises of stainless steel.

19. A method of manufacturing a fuel injector in accordance with claim 15, wherein said injector body comprises of ferritic stainless steel.
